(19) United States
(12) Patent Application Publication
(10) Pub. No.: US 2008/0188370 A1
(43) Pub. Date: Aug. 7, 2008

(54) Use of Titanium Dioxide Mixed Oxide as a Photocatalyst

(75) Inventors: Reinhard Vormberg, Neuberg (DE); Kai Schumacher, Hofheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Evonik Degussa GmbH, Essen (DE)

(21) Appl. No.: 11/995,837

(22) PCT Filed: Jul. 6, 2006
(86) PCT No.: PCT/EP2006/063993

§ 371 Date: Jan. 16, 2008

(30) Foreign Application Priority Data
Aug. 9, 2005 (EP) 05017324.4

(51) Int. Cl. B01J 21/06; B01J 23/10; B01J 23/00; B01J 23/06

(52) U.S. Cl. 502/242; 502/304; 502/350; 502/351; 502/307; 502/309; 502/343; 502/342

(57) ABSTRACT

Use of titanium dioxide mixed oxide as a photocatalyst, wherein the titanium dioxide mixed oxide has the following features: BET surface area: 5 to 300 m2/g, mixed oxide component: one or several oxides from the group comprising aluminium, cerium, silicon, tungsten, zinc and zirconium, proportions: titanium dioxide more than 97.5 wt. %, mixed oxide component ≧0.1 to <2 wt. %, sum of the contents of titanium dioxide and secondary component at least 99.5 wt. %, each based on the total quantity of the mixed oxide, titanium dioxide content of the primary particles containing intergrown rutile and anatase phases.

The invention relates to the use of titanium dioxide mixed oxide as a photocatalyst.

From EP-A-778812, titanium dioxide mixed oxide particles for photocatalytic uses made by reaction of titanium tetrachloride and a chloride of silicon, germanium, boron, tin, niobium, chromium, aluminium, gold, silver or palladium in a flame are known. Of particular importance here are silicon- and aluminium-titanium mixed oxide particles. It is disclosed that such mixed oxide powders with a silicon dioxide content of ca. 5 to 10 wt. % are not optimal for photocatalytic purposes. Further, it is stated that the anatase content and hence the photocatalytic activity in such mixed oxide powders increases with increasing silicon dioxide content. From these statements, it is to be inferred that photocatalytic activity only appreciably arises beyond 10% silicon dioxide content.

From DE-A-10260718, titanium dioxide particles sheathed in silicon dioxide with a silicon dioxide content of 0.5 to 40 wt.-% are known. The particles display low photocatalytic activity and are therefore preferably used in sunscreen formulations.

In DE-A-4235996, silicon-titanium mixed oxide particles with a silicon dioxide content of 1 to 30 wt. %, based on the mixed oxide are described. The mixed oxide displays high temperature resistance, however the silicon dioxide content reduces the photocatalytic activity.

From WO03/037994, titanium dioxide particles coated with the oxides of silicon, aluminium, cerium and/or zirconium are known. The coating results in effective protection from photocatalytic reactions. The particles are obtained by precipitating a precursor of silicon dioxide onto titanium dioxide particles in the presence of a surface-modifying substance and are optionally then subjected to hydrothermal treatment. The silicon dioxide content, based on titanium dioxide, is 0.1 to 10 wt.-%. Beyond 0.1 wt.-% a marked decrease in the photocatalytic activity is already observed.

From EP-A-988853 and EP-A-1284277, titanium dioxide particles sheathed in silicon dioxide are known, wherein a silicon dioxide shell leads to a reduction in the photocatalytic activity. The particles therefore are mainly used in sunscreen formulations.

The technical teaching imparted by the state of the art is that mixed oxide components with titanium dioxide lead to a decrease in the photocatalytic activity.

The present invention was based on the problem of providing a substance suitable for use as a photocatalyst.

The object of the invention is the use of a titanium dioxide mixed oxide as a photocatalyst, wherein the titanium dioxide mixed oxide has the following features:
BET-surface area: 5 to 300 m²/g,
mixed oxide component: one or several oxides from the group comprising aluminium, cerium, silicon, tungsten, zinc and zirconium
proportions:
   titanium dioxide more than 97.5 wt. %,
   mixed oxide component ≧0.1 to <2 wt. %,
   sum of the contents of titanium dioxide and secondary component at least 99.5 wt. %, each based on the total quantity of the mixed oxide,
titanium dioxide content of the primary particles including intergrown rutile and anatase phases.

Preferably a titanium dioxide mixed oxide can be used which contains more than 98.5 wt.-% titanium dioxide and ≧0.2 to <1 wt. % of the mixed oxide component. Particularly preferably, a titanium dioxide mixed oxide can be used which contains more than 99.0 wt. % of titanium dioxide and ≧0.3 to <0.5 wt. % of the mixed oxide component.

Mixed oxide in the sense of the invention includes the mixed oxide in the form of a powder, in a dispersion or as a coating component of a coated substrate.

The dispersion can contain water and/or an organic solvent or solvent mixture as the liquid phase. The content of titanium dioxide mixed oxide in the dispersion can be up to 70 wt.-%. Further the dispersion can contain additives known to the skilled person for adjustment of the pH value and also surfactant substances.

The coated substrate can preferably be obtained by applying the dispersion onto a substrate, for example glass or a polymer, and then subjecting it to heat treatment.

The number of mixed oxide components besides titanium dioxide is preferably 1 or 2 and particularly preferably 1.

The BET surface area of the titanium dioxide mixed oxide is determined in accordance with DIN 66131. Preferably the BET surface area of the titanium dioxide mixed oxide is about 40 to 120 m²/g.

Mixed oxide should be understood to mean the intimate mixing of titanium dioxide and the other mixed oxide component or components X₁, X₂, . . . Xₙ at the atomic level with the formation of X₁—O—Ti—, X₂—O—Ti, . . . Xₙ—O—Ti— bonds. In addition to this, the primary particles can also have regions wherein the mixed oxide components are present together with titanium dioxide.

Primary particles should be understood to mean the smallest particles, not further divisible without the breaking of chemical bonds. These primary particles can grow into aggregates. Aggregates are characterized in that their surface area is smaller than the sum of the surface areas of the primary particles of which they consist. Titanium dioxide mixed oxides with a low BET surface area can be present entirely or predominantly in the form of non-aggregated primary particles, while titanium dioxide mixed oxides of higher BET surface area can have a higher degree of aggregation or be completely aggregated.

By counting from TEM photographs (TEM=Transmissions Electron Microscopy) in combination with EDX (Energy Dispersive X-ray Analysis, energy dispersive X-ray spectroscopy) it was found that primary particles with X—O—Ti bonds are present in a proportion of at least 80%, based on the total quantity of the titanium dioxide mixed oxide. As a rule, the content is more than 90%, in particular more than 95%.

The sum of the contents of titanium dioxide and the other mixed oxide components, based on the total quantity of the mixed oxide, is at least 99.5 wt. %. Moreover, the titanium dioxide mixed oxide can contain traces of impurities from the starting substances, and also impurities caused by the process. These impurities can amount to a maximum of up to 0.5 wt. %, but as a rule are not more than 0.3 wt. %.

The content of the mixed oxide components, based on the total quantity of the mixed oxide, is from ≧0.1 to <2 wt. %. Titanium dioxide mixed oxide with contents, apart from titanium dioxide, of less than 0.1 wt. % show photo-activity comparable to a titanium dioxide with comparable features. At contents of more than 1 wt. %, decreasing photoactivity is already to be expected.

The crystalline rutile and anatase fractions in the titanium dioxide mixed oxide can absorb light quanta, as a result of which an electron is promoted from the valence band into the conduction band. For rutile the gap between valence and conduction band is about 3.05 eV, corresponding to an absorption at 415 nm, for anatase the gap is 3.20 eV, corresponding to an absorption at 385 nm. If the free electrons migrate to the surface, they can trigger a photocatalytic reaction there.

The use according to the invention assumes a titanium dioxide mixed oxide wherein the primary particles contain a rutile and anatase phase. This feature is essential in order to achieve high photocatalytic activity. A possible cause for this effect could be that the quanta captured by the rutile fraction are passed on to the anatase fraction, as a result of which the probability of generating reactive electrons at the surface rises.

Preferably a titanium dioxide mixed oxide with a rutile/anatase ratio of 1/99 to 99/1 can be used. Titanium dioxide mixed oxides wherein the anatase phase predominates are particularly preferred. These can in particular be rutile/anatase ratios of 40/60 to 5/95.

The mixed oxide component present together with titanium dioxide can be both amorphous and/or crystalline.

Preferably a titanium-silicon mixed oxide can be used wherein the silicon dioxide fraction is amorphous.

The structure of the titanium dioxide mixed oxide used can be of diverse types. Thus it can be present in the form of aggregated primary particles or individual non-aggregated primary particles can be present. The mixed oxide component can be randomly distributed across the primary particles or, in particular for silicon dioxide, configured in the form of a shell around a titanium dioxide core.

Preferably, pyrogenically produced titanium dioxide mixed oxide can be used. Pyrogenically produced titanium dioxide mixed oxide in the sense of the invention should be understood to mean one which is obtained by reaction of hydrolysable and/or oxidisable starting compounds in the presence of steam and/or oxygen in a high temperature zone. The titanium dioxide mixed oxide thus produced consists of primary particles, which have no internal surface and bear hydroxyl groups on their surface.

### EXAMPLES

### A. Production of the Titanium Dioxide Mixed Oxides

### Example 1

4.1 kg/hr of TiCl₄ and 0.05 kg/hr of SiCl₄ are evaporated. By means of nitrogen, the vapours together with 2.0 Nm³/hr of hydrogen and 9.1 Nm³/hr of dried air, are mixed in the mixing chamber of a burner of known design, and fed into a water-cooled flame pipe via a central pipe at the end whereof the reaction mixture is ignited, and there burnt.

The titanium dioxide mixed oxide formed is then separated in a filter. Adhering chloride is removed by a treatment with moist air at ca. 500-700° C.

Example 2 is performed similarly to Example 1. The quantities used and the experimental conditions of Examples 1 and 2 are reproduced in Table 1, and the physical and chemical properties in Table 2.

Powders 3 and 4 are pyrogenically produced titanium dioxide powders.

### B. Photocatalytic Activity

The photocatalytic activity of the powders 1 to 4 with regard to fatty acid degradation is investigated.

Stearic acid methyl ester (abbr: methyl stearate) dissolved in n-hexane is used as the test substance. Since for the activity tests this substance is applied as a thin fat film onto the surface to be tested, a layer of the powders 1 to 4 on the support material glass is first prepared.

For this, a dispersion of 120 mg of each powder 1 to 4 in 2 ml of isopropanol is prepared and applied onto a glass surface of 4×9 cm. The layers are then aged at 100° C. for 60 mins in the muffle furnace.

A defined quantity of a methyl stearate solution (5 mmol/l) in n-hexane is applied onto the layers obtained and these are firstly irradiated for 15 minutes with 1.0 mW/cm² of UV-A light.

For the determination, ca. 500 μl of a methyl stearate solution (5 mmol/l) in n-hexane are applied onto each of the mixed oxide layers, so that, based on the quantity washed off (5 ml n-hexane) a concentration of ca. 0.5 mmol/l is obtained. The values determined by gas chromatography (FID) are in Table 3.

After the end of the irradiation, the methyl stearate that remained on the mixed oxide layers was washed off with 5 ml of n-hexane and quantitatively determined by gas chromatography (FID).

Comparison with a previously obtained reference value, determined by application of the defined quantity of methyl stearate and immediately washing off the methyl stearate layer with n-hexane without previous irradiation provides information concerning the photocatalytic activity of the layers.

Table 3 shows the quantity of methyl stearate that remained on the TiO₂ layers after 5 mins irradiation with 1.0 mW/cm² of UV-A light.

As a reference or control experiment, powder 2 was used for the degradation of methyl stearate in a “dark experiment”.

After application of 500 μl of the (methyl stearate in n-hexane) solution, the layers are kept for one hour in the dark. Next, the layers are washed off with 5 ml of n-hexane and the methyl stearate concentration determined by gas chromatography. The degradation rate is negligible, at 40 μM/hr.

The determination of the photon efficiency is subject to an error of max. 10%. The deviation of the dark experiment value from the starting concentration (reference value) thus lies within the measurement error range. Consequently, the degradation rates can be converted directly into the corresponding photon efficiencies. The basis for the calculation is the initial degradation rates of the individual samples, that is in each case the rates determined after the shortest irradiation time.

Calculation of the photon efficiency for Example 3:

Photon flux at 350 nm, 36 cm² irradiated area and 1.0 mW/cm²: 3.78*10⁻⁴ mol*hv*hr⁻¹
Volume analysed: 5 ml=0.005 l
Degradation rate: 1520 μM/hr*0.005 l=7.6*10⁻⁶ mol*hr⁻¹

$$Photon efficiency = degradation rate * photon flux$$

$$\begin{matrix}Photon efficiency = 7.6 * {10}^{- 6} mol * {hr}^{- 1} * 3.78 * {10}^{- 4} mol * \\ hv * {hr}^{- 1} \\ = 2.01 \times {10}^{- 2} \\ = 2.01 \%\end{matrix}$$

The calculation of the photon efficiency of the powders of Examples 1, 2 and 4 is performed analogously. The results are reproduced in Table 2.

The results show that with the use of a titanium dioxide mixed oxide with the features according to the invention, the photocatalytic activity is higher than with titanium dioxide with comparable features and comparable production process.

It is surprising that titanium mixed oxide powders with a content of the mixed oxide component of ≧0.1 to <2 wt. %, whose titanium dioxide fraction contains intergrown rutile and anatase phases can be used as effective photocatalysts. The state of the art would in fact suggest that the mixed oxide component would lead to a decrease in the photo-catalytic activity.

TABLE 1
Experimental conditions in the production of the
powders 1 and 2 used

Example

| | | 1 | 2 |
|---|---|---|---|
| TiCl₄ | kg/hr | 4.1 | 4.1 |
| SiCl₄ | kg/hr | 0.05 | 0.05 |
| H₂ | Nm³/hr | 2.0 | 2.0 |
| Air | Nm³/hr | 9.1 | 14.0 |
| Secondary air | Nm³/hr | 15 | 15 |

TABLE 2
Analytical data on the powders 1 to 4 used

| Example | | 1 | 2 | 3 | 4 |
|---|---|---|---|---|---|
| TiO₂ content | wt. % | 99.41 | 99.46 | >99.5 | >99.5 |
| SiO₂ content | wt. % | 0.41 | 0.45 | <0.002 | <0.002 |
| BET | m²/g | 48 | 83 | 50 | 90 |
| Rutile/anatase | | 39/61 | 24/76 | 20/80 | 10/90 |
| Photon efficiency | % | 3.3 | 5.2 | 2.01 | 4.4 |
| Photoactivity*) | | 1.64 | 2.59 | 1 | 2.19 |

*)based on Aeroxide ® TiO₂ P25, Degussa = 1;

TABLE 3
Degradation rates of methyl stearate

| | | Powder | | | |
|---|---|---|---|---|---|
| | | 1 | 2 | 3 | 4 |
| c₀ methyl stearate | mmol/l | 0.46 | 0.48 | 0.43 | 0.4 |
| c₅ₘᵢₙ methyl stearate | mmol/l | 0.27 | 0.13 | 0.05*) | 0.12 |
| Methyl stearate | μmol/ | 2520 | 3960 | 1520 | 3360 |
| degradation rate | l × hr | | | | |

*)c₁₅ₘᵢₙ instead of c₅ₘᵢₙ;

1. A titanium dioxide mixed oxide as a photocatalyst, wherein the titanium dioxide mixed oxide has the following features:
BET surface area: 5 to 300 m²/g,
a mixed oxide component: one or several oxides selected from the group consisting of aluminium, cerium, silicon, tungsten, zinc, zirconium, and mixtures thereof
proportions:
titanium dioxide more than 97.5 wt. %,
the mixed oxide component ≧0.1 to <2 wt. %,
the sum of the contents of titanium dioxide and a secondary component at least 99.5 wt. %, each based on the total quantity of the mixed oxides, and
the titanium dioxide content of the primary particles including intergrown rutile and anatase phases.

2. The titanium dioxide mixed oxide according to claim 1, wherein a rutile/anatase ratio of the mixed oxide component is 1/99 to 99/1.

3. The titanium dioxide mixed oxide according to claim 1, wherein the secondary component of the mixed oxide component is silicon dioxide.

4. The titanium dioxide mixed oxide according to claim 1, wherein the titanium dioxide mixed oxide is a pyrogenically produced titanium dioxide mixed oxide.

5. A method for providing a photocatalyst comprising applying a titanium dioxide mixed oxide according to claim 1 to a substrate.
